(19) United States
(12) Patent Application Publication
(10) Pub. No.: US 2023/0285944 A1
(43) Pub. Date: Sep. 14, 2023

(54) Molybdenum Carbide Catalysts

(71) Applicant: NULIFE GreenTech Inc., Saskatoon (CA)

(72) Inventors: Ajay Dalai, Saskatoon (CA); Venu Borugadda, Saskatoon (CA); Rishav Chand, Bhubaneswar (IN)

(21) Appl. No.: 18/040,449

(22) PCT Filed: Aug. 5, 2021
(86) PCT No.: PCT/CA2021/051091

§ 371 Date: Feb. 3, 2023

Related U.S. Application Data
(60) Provisional application No. 63/061,505, filed on Aug. 5, 2020.

(51) Int. Cl. B01J 27/22; B01J 35/10; B01J 37/02; B01J 37/08; B01J 37/18

(52) U.S. Cl. CPC B01J 27/22; B01J 35/1038; B01J 35/1019; B01J 37/0201; B01J 37/0236; B01J 37/08; B01J 37/18

(57) ABSTRACT

The present invention provides a hydrodeoxygenation catalyst comprising molybdenum carbide (Mo₂C) supported on a bio-residue support. The catalyst has a concentration of strong acidic sites of more than 0.25 mmol/g of the catalyst, as measured by ammonia temperature programmed desorption (NH₃-TPD) analysis, and a BET surface area of 100 m²/g to 200 m²/g. The invention also relates to a process for preparing a bio-residue supported molybdenum carbide (Mo₂C) catalyst, and a process for hydrodeoxygenation of an oxygen rich feedstock using the catalyst of the invention.

### FIELD OF THE INVENTION

The present invention pertains to the field of molybdenum carbide catalysts that can be used in a process for preparing hydrocarbons, in particular a bio-residue supported molybdenum carbide catalyst, method of synthesizing, and use thereof in hydrodeoxygenation of an oxygen-rich feedstock.

### BACKGROUND OF THE INVENTION

In view of depletion of energy resources and environmental pollution due to increased consumption of fossil-derived fuels over the years, biomass-derived fuels (bio-fuels), such as pyrolysis oils, bio-crudes, and vegetable oils, and fatty acid methyl esters are found to be promising substitutes for conventional fuels. The efficient utilization of bio-fuels does not generate much SOₓ emission, and NOₓ emissions is reduced more than 50% when bio-mass derived fuels are complemented with fossil-derived fuels. Therefore, biofuels have less adverse effects on the environment as compared to fossil-derived fuels.

Bio-fuels may be derived from biomass derived crude oils (aka bio-crudes). Although bio-crudes cannot be used as a fuel directly in diesel and gasoline engines or as aviation fuel due to their unfavorable physicochemical properties and chemical compositions. The intensity of efforts in overcoming these challenges varies depending on the nature of the feedstock, type of thermo-chemical process and the process condition, used for biofuel production.

Hydrotreating, hydro (catalytic) cracking, emulsification, blending, hydrodeoxygenation, solvent addition, and esterification are used as upgrading techniques to produce liquid transportation fuels from biomass-derived crude oils. Among them, the hydrodeoxygenation process is found to be favorable due to the acceptable fuel properties and quality of the fuel achieved via this process.

Hydrodeoxygentaion is a catalytic conversion process, which involves high temperature and pressure in the presence of hydrogen and catalyst to remove oxygen atoms from the inherent components of the bio-crude molecules. Typical hydrodeoxygenation catalysts consist of support material (either acidic such as alumina, or non-acidic like carbon, silica-gel), an active metal (such as Co, Cu, Ni, Mo, Fe) and a promoter. Often, hydrotreating catalysts prepared with Co—Mo, Ni—Mo, and Fe—Mo impregnated on a support material (zeolites or γ-Al₂O₃) are used as hydrodeoxygenation catalysts. Due to the high oxygen content of bio-crudes, animal fats, plant seed oils and used cooking oils/greases hydrotreating catalysts are deactivated at a faster rate when used as hydrodeoxygenation catalysts. Deactivation of these catalysts can be attributed to the active oxygen functionalities posed by aldehydes, ketones, carboxylic acids, carbohydrates, thermally degraded lignin, water and alkali metals, coke formation, water poisoning and leaching of support material.

In addition, cost is major factor in developing a hydrodeoxygenation catalyst, which depends on the nature of the support, active metal(s) and an optional promotor. The higher the concentration of metals or promotors on the catalyst, the higher is the cost.

Sulphur-free noble-metal catalysts are known to be efficient in activating molecular hydrogen atoms and hence, they exhibit better catalytic activity and stability on different support materials. However, noble-metal catalysts are expensive and the costs involved do not justify their use in large-scale operations.

Several other attempts have been made to produce direct drop-in fuels via upgrading of bio-crudes.

However, currently, there is no commercially viable hydrodeoxygenation catalyst for reducing levels of oxygen in the bio-crude produced by thermochemical technologies (such as pyrolysis and hydrothermal liquefaction).

Therefore, there is a need for an efficient hydrodeoxygenation catalyst, and a process that would result in an economical upgrading of bio-crudes into liquid transportation bio-fuels (direct drop-in fuels), and upgrading of renewable oils to improve their commercial utility.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a novel molybdenum carbide catalyst for efficient hydrodeoxygenation of an oxygen-rich feedstock, and a process for synthesizing the catalyst.

In accordance with an aspect of the present invention, there is provided a hydrodeoxygenation catalyst comprising molybdenum carbide (Mo₂C) supported on a bio-residue support, wherein the catalyst has a concentration of strong acidic sites of more than 0.25 mmol/g of the catalyst, as measured by ammonia temperature programmed desorption (NH₃-TPD) analysis.

In accordance with another aspect of the invention, there is provided a method for preparing a bio-residue supported molybdenum carbide (Mo₂C) catalyst, which comprises: a) treating the bio-residue with an acid at a temperature of about 50° C. to about 150° C. to introduce oxygen functional groups on the surface to provide an oxygenated bio-residue; b) impregnating the oxygenated bio-residue with a molybdenum precursor to achieve Mo loading of about 10%-20% w/w to provide a precursor-impregnated bio-residue; c) drying and calcining the precursor-impregnated bio-residue under an inert atmosphere, at a temperature of about 450 to about 600 to provide a calcined precursor-impregnated-bio-residue; and d) reducing the calcined precursor-impregnated-bio-residue in hydrogen atmosphere at a H₂ flow rate of 75-125 mL/min at a temperature of about 600 to about 800 to obtain the bio-residue supported molybdenum carbide catalyst.

In accordance with another aspect of the invention, there is provided a process for hydrodeoxygenation of an oxygen-rich feedstock, which comprises hydrotreating the feedstock at a temperature of about 250° C. to about 350° C., and a pressure of about 3 MPa to about 7 MPa, for about 1 h- about 5 h in the presence of the bio-residue supported molybdenum carbide (Mo₂C) catalyst as defined in any one of claims 1 to 5, with catalyst loading of 1-5% w/w of the amount of bio-crude in the feedstock.

### BRIEF DESCRIPTION OF THE FIGURES

The invention will now be described by way of an exemplary embodiment with reference to the accompanying figures. In the figures:

FIG. 1 depicts pore size distributions of a molybdenum carbide catalyst in accordance with an embodiment of the present invention.

FIG. 2 depicts N2 adsorption-desorption isotherms for a molybdenum carbide catalyst in accordance with an embodiment of the present invention.

FIG. 3 depicts TGA curves depicting weight loss for a molybdenum carbide catalyst in accordance with an embodiment of the present invention.

FIG. 4 depicts DTG curves depicting rate of weight loss for a molybdenum carbide catalyst in accordance with an embodiment of the present invention.

FIG. 5 depicts XRD patterns for a molybdenum carbide catalyst in accordance with an embodiment of the present invention.

FIG. 6 depicts NH₃-TPD curve for a molybdenum carbide catalyst in accordance with an embodiment of the present invention.

FIG. 7 depicts Mo 3d XPS narrow scan spectrum deconvolution of Mo/AC catalyst.

FIG. 8 depicts Mo 3d XPS narrow scan spectrum deconvolution of Mo/MWCNT catalyst.

FIG. 9 depicts Mo 3d XPS narrow scan spectrum deconvolution of a Mo/BR catalyst in accordance with an embodiment of the present invention.

FIG. 10 depicts effect of pressure on oxygen reduction (Temperature: 300° C., Reaction Time: 3 h, Catalyst Loading: 3% w/w).

FIG. 11 depicts effect of reaction time on oxygen reduction (Temperature: 300° C., Pressure: 5 MPa, Catalyst Loading: 3% w/w).

FIG. 12 depicts effect of temperature on oxygen reduction (Pressure: 5 MPa, Reaction Time: 2 h, Catalyst Loading: 3% w/w).

FIG. 13 depicts effect of catalyst loading on oxygen reduction (Temperature: 325° C., Pressure: 5 MPa, Reaction Time: 2 h).

FIG. 14 depicts distribution of n-alkanes in bio-crude blends before and after hydrodeoxygenation.

FIG. 15 depicts change in volume of bio-crude blends as a function of boiling point.

FIG. 16. ¹H NMR spectra for bio-crude blends before and after hydrodeoxygenation.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “about” refers to approximately a +/−10% variation from a given value. It is to be understood that such a variation is always included in any given value provided herein, whether or not it is specifically referred to.

As used herein, the term “bio-residue” refers to a carbonaceous material obtained by thermochemical conversion of biomass, such as thermal decomposition of biomass in the absence of oxygen, pyrolysis, torrefaction, hydrothermal carbonization, hydrothermal liquefaction, etc.

As used herein, the term “bio-crude” refers to a crude-oil that can be produced through contemporary processes from biomass, rather than a crude oil produced by the slow geological processes involved in the formation of fossil fuels.

As used herein, the term “renewable fuel” refers to a fuel produced from renewable resources.

Examples of renewable fuel include: biofuels produced from biomass (e.g. vegetable oil used as fuel, ethanol, methanol, etc.) and Hydrogen fuel (when produced with renewable processes).

As used herein, the term “oxygen-rich feedstock” refers to a feedstock comprising levels of oxygen, that renders the feedstock unsuitable for direct use, for example, as a fuel for engines.

As used herein, the term “biomass” refers to feedstocks derived from plants, microorganisms (such as algae/microalgae), agricultural residues/waste, forestry residues/waste, municipal waste, yard waste, manufacturing waste, landfill waste, animal waste, sewage sludge, animal by-products, etc. and the like.

Examples of plant materials include wood, woodchips, sawdust, bark, seeds, straw, grass, and the like. Agricultural residue may include husks such as rice husk, coffee husk etc., maize, corn stover, oilseeds, cellulosic fibers like coconut, jute, and the like, other wastes such as coconut shell, almond shell, walnut shell, sunflower shell, and the like. Agricultural residue also includes material obtained from agro-processing industries such as deoiled residue, gums from oil processing industry, bagasse from sugar processing industry, cotton gin trash and the like.

The present invention provides a bio-residue supported molybdenum carbide catalyst, which exhibits superior catalytic activity as compared to similar molybdenum carbide catalysts supported on activated carbon (AC) or multi-walled carbon nanotubes (MWCNT).

The bio-residue supported molybdenum (Mo/BR) carbide catalyst of the present invention has higher concentration of strong acidic sites (in comparison to AC or MWCNT supported catalysts) as measured by ammonia temperature programmed desorption analysis (NH3-TPD), along with a high percentage of molybdenum dispersion, high concentration of β-Mo₂C on its surface, and/or an optimum average pore size, which may be attributed to superior catalytic activity of the Mo/BR catalyst.

The Mo/BR catalyst of the present invention has a concentration of strong acidic sites more than 0.25 mmol/g of the catalyst, as measured by ammonia temperature programmed desorption analysis (NH3-TPD).

In some embodiments, the concentration of strong acidic sites is more than 0.35 mmol/g of the catalyst. In some embodiments, the concentration of strong acidic sites is up to 1 mmol/g of the catalyst.

In some embodiments, Mo/BR catalyst of the present invention has a BET surface area of 100-200 m²/g. In some embodiments, Mo/BR catalyst of the present invention has a BET surface area of 100-150 m²/g.

BET surface area is a well-known term in the relevant field and refers to the surface area of solid or porous materials measured via BET surface analysis procedures/methods based on the BET theory (abbreviated from Brunner-Emmett-Teller theory) to obtain information about their physical structure.

In some embodiments, the Mo/BR catalyst of the present invention has a concentration of strong acidic sites more than 0.25 mmol/g of the catalyst, and a BET surface area of 100-200 m²/g.

In some embodiments, Mo/BR catalyst of the present invention has an average pore size more than 7 mm and up to 13 nm. In some embodiments, the Mo/BR catalyst of the present invention has an average pore size of about 7.5 nm to about 12 nm. In some embodiments, Mo/BR catalyst of the present invention has an average pore size of about 8 nm to about 10 nm.

In some embodiments, Mo/BR catalyst of the present invention has a pore volume of about 0.2 cm³/g to about 0.4 cm³/g. In some embodiments, Mo/BR catalyst of the present invention has a pore volume of about 0.2 cm³/g to about 0.3 cm³/g.

In some embodiments, the Mo/BR catalyst of the present invention has surface concentration of molybdenum of more than 1%. In some embodiments, the surface concentration of molybdenum is up to 10%.

In some embodiments, the Mo/BR catalyst of the present invention has surface concentration of MO₂C more than 0.2%. In some embodiments, the surface concentration of MO₂C is more than 0.3%. In some embodiments, the surface concentration of MO₂C is up to about 5%. In some embodiments, the surface concentration of MO₂C is about 0.3% to about 3%.

In some embodiments, the Mo/BR catalyst has molybdenum dispersion of about 2% to about 15%. In some embodiments, the Mo/BR catalyst has molybdenum dispersion of about 2% to about 10%.

In some embodiments, the Mo/BR catalyst of the present invention has metallic surface area about 1.4 to about 6.0 m²/g of catalyst.

In another aspect, the present invention provides a process for preparing a bio-residue supported molybdenum (Mo/BR) carbide catalyst, which starts with treating the bio-residue with an acid at a temperature of about 50° C. to about 150° C. to introduce oxygen functional groups on the surface to provide an oxygenated bio-residue. The oxygenated bio-residue is impregnated with a molybdenum precursor to achieve Mo loading of 10%-20% by weight of the catalyst to obtain a precursor-impregnated bio-residue. The precursor-impregnated bio-residue is dried and calcined under an inert atmosphere, at a temperature of about 450° C. to about 600° C. to provide a calcined precursor-impregnated-bio-residue. The calcined precursor-impregnated-bio-residue is then reduced in hydrogen atmosphere at a H₂ flow rate of 75-125 mL/min at a temperature of about 600° C. to about 800° C. to obtain the Mo/BR carbide catalyst. In some embodiments, the H₂ flow rate is about 100 mL/min.

The oxygenated bio-residue can be impregnated via commonly known methods, such as incipient wetness impregnation method, dip method impregnation and/or a spray impregnation.

In a preferred embodiment, the oxygenated bio-residue is impregnated via incipient wetness impregnation method.

In some embodiments, the process further comprises passivating the obtained Mo/BR carbide catalyst by flowing about 1-2% O₂ in N₂ at a flow rate of about 50 mL/min to about 250 mL/min over the surface of the catalyst.

In some embodiments, in the drying step the precursor-impregnated bio-residue is dried under vacuum at about 80° C. to about 120° C. prior to the calcining step.

In some embodiments, the bio-residue is preheated at a temperature about 300° C. to about 350° C. prior to treatment with the acid.

Suitable acids for the treatment of bio-residue include HNO₃, H₂SO₄, HCl, HF, etc. In some embodiments, the molar concentration of acid is from about 0.1M to 7M. In some embodiments, the molar concentration of acid is from 0.1M to 1M.

In some embodiments, the bio-residue is treated with about 0.5-7 molar HNO₃. In some embodiments, the molar concentration of HNO₃ is 4-6M. In some embodiments, the molar concentration of HNO₃ is about 6M.

Suitable molybdenum precursor for the process include Molybdenyl acetylacetonate (C₁₀H₁₆MoO₆), Molybdenum hexacarbonyl (Mo(CO)₆), Molybdenum chloride (Cl₁₀Mo₂), Ammonium heptamolybdate ((NH₄)₆Mo₇O₂₄), Ammonium orthomolybdate ((NH₄)₂MoO₄), Potassium heptamolybdate (K₂MoO₄), Ammonium heptamolybdate tetrahydrate ((NH₄)₆Mo₇O₂₄·4H₂O), heteropolyoxomolybdates ((NH₄)₃[CoMo₆O₂₄H₆]·7H₂O) and Molybdenum(II) acetate dimer (C₈H₁₂Mo₂O₈).

In some embodiments, the molybdenum precursor is ammonium heptamolybdate.

The bio residue supported catalyst can be in the form pellets, powder, granules, ash, extrudite, etc.

In some embodiments, the process further comprises adding a binder to the calcined precursor-impregnated-bio-residue to form pellets, granules and/or tablets of desired shape and/or size.

Suitable binders for the pelletization of bio-residue include bentonite clay, calcined clay, fly ash, slaked lime, etc. In some embodiments the binder is bentonite clay.

In some embodiments, the binder is added in an amount about 10% to 20% by weight of the calcined precursor-impregnated-bio-residue.

The pellets can be formed in any desired shape such a cylindrical shape, bilobed, trilobed, and/or quadrilobed. In some embodiments the pellets have a cross sectional diameter from 0.5 mm to about 2 mm.

The above can be carried out as a batch process or a continuous flow process.

The Mo/BR catalyst of the present invention exhibits superior catalytic activity in hydrodeoxygenation reaction in the process of converting oxygen-rich feedstock such as bio crude oil, pyrolysis oil (produced from forestry and wood wastes), vegetable oils, fatty acid methyl esters, animal fat, bio-lipids, etc., into transportation fuels such as diesel, gasoline, jet fuel, etc.

The Mo/BR catalyst of the present invention exhibits superior catalytic activity in upgrading of renewable bio-crudes and bio-oils into transportation fuels.

The Mo/BR catalyst of the present invention exhibit superior activity in co-processing of bio-crude with petroleum refinery distillate relative to the conventional carbon based supports such as AC and MWCNT.

In another aspect, the present invention provides a process for hydrodeoxygenation of a biomass-derived oxygen-rich feedstock, which involves hydrotreating the feedstock at a temperature of about 250° C. to about 350° C., and a pressure of about 3 MPa to about 7 MPa, for about 1 h-5 h in the presence of the bio-residue supported molybdenum carbide (Mo₂C) catalyst as described herein, with catalyst loading of about 1-5% w/w of the amount of bio-crude in the feedstock.

In some embodiments, the biomass derived oxygen-rich feedstock comprises bio-crude, pyrolysis oil, vegetable oil, bio-lipids or a combination (blend) thereof, optionally in combination with a fuel/gas oil, such as vacuum gas oil, heavy gas oil, etc.

In some embodiments, oxygen-rich feedstock comprises 5-15% by weight of the bio-crude in a refinery distillate. The refinery distillate may be untreated, partially hydrotreated or fully hydrotreated.

“In some embodiments, the bio-residue is obtained by thermochemical conversion or decomposition at pressures of about 2600 psi to about 3400 psi and a temperature of about 270° C. to about 370° C.” In some embodiments, the thermochemical conversion or decomposition is carried out at pressures of about 2800 psi to about 3300 psi and a temperature of about 280° C. to about 360° C.

To gain a better understanding of the invention described herein, the following examples are set forth. It will be understood that these examples are intended to describe illustrative embodiments of the invention and are not intended to limit the scope of the invention in any way.

### EXAMPLES

### Example 1: Synthesis of Bio-Residue Supported Molybdenum Carbide Catalyst

The Bio-residue supported molybdenum carbide catalyst (MO/BR) was synthesized via Carbothermal Hydrogen Reduction (CHR) method.

### 1a) Synthesis of Powdered Bio-Residue Supported Molybdenum Carbide Catalyst

A bio-residue support was prepared from a bio-residue obtained after ethyl acetate extraction of a hydrothermal liquefaction (HTL) reaction mixture to separate bio-crude from canola oil bearing bentonite clay was heated at about 315° C. to remove traces of bio-crude present in the sample post extraction. The support was treated with 6M HNO₃ at about 80° C. for about 3 hours in order to introduce oxygen functional groups on the surface. The mixture was then cooled, filtered and washed with distilled water several times till the pH of the filtrate became neutral, and dried under vacuum at about 100° C. Molybdenum was then impregnated onto the support via incipient wetness impregnation method, using ammonium heptamolybdate precursor. The precursor was dissolved in deionized water and the solution was added drop-wise to the support to achieve about 13 wt. % Mo loading. The precursor-impregnated support was then dried under vacuum at about 100° C. and thereafter, calcined under N2 flow at about 500° C. for 3 hours. The sample was heated till 700° C. with a H₂ flow of 100 mL/min in a tubular furnace at a rate of 10° C./min. The sample was held and reduced at this temperature for 3 hours. Finally, powdered Mo/BR catalyst was quenched to room temperature under nitrogen flow and passivated in a 200 mL/min flow of 1% O₂ in N₂ for 45 minutes.

### 1b) Synthesis of Pelletized Bio-Residue Supported Molybdenum Carbide Catalyst

An alternative bio-residue support was prepared from a bio-residue obtained in a similar manner to example 1 a). The support was treated with 0.5M HNO₃ at about 80° C. for about 3 hours. The mixture was then cooled, filtered and washed with distilled water several times till the pH of the filtrate became neutral, and dried under vacuum at about 100° C. Molybdenum was then impregnated onto the support via incipient wetness impregnation method, using ammonium heptamolybdate precursor. The precursor was dissolved in deionized water and the solution was added drop-wise to the support to achieve about 15 wt. % Mo loading and, thereafter calcined under N₂ flow at about 500° C. for 3 hours. Then bentonite clay was mixed in to the calcined-precursor-impregnated support to achieve a 10 wt. % bentonite clay loading. This mixture was then pelletized to achieve a trilobe shape with a cross sectional diameter of about 1.2 mm. The sample was heated till 700° C. with a H₂ flow of 100 mL/min in a tubular furnace at a rate of 10° C./min. The sample was held and reduced at this temperature for about 3 hours. Finally, pelletized Mo/BR catalyst was quenched to room temperature under nitrogen flow and passivated in a 50 mL/min flow of 1% O₂ in N₂ for 45 minutes.

### Example 2: Synthesis of Carbon-supported Molybdenum Carbide Catalysts

Two carbon-supported catalysts were also prepared following the procedure of Example 1, wherein the support materials were: a) commercial activated carbon (AC), and b) commercial multi-walled carbon nanotubes (MWCNT). The powdered activated carbon was purchased from Cabot Corporation, Amersfoort, Netherlands and the multi-walled carbon nanotubes were obtained from M. K. Impex Corp., Mississauga, Canada.

### Example 3: Characterization of Synthesized Catalysts

### a1) N₂ Physisorption and CO Chemisorption Analysis of the Catalyst Prepared in Examples 1a and 2:

The surface area and porosity analysis for the support materials and synthesized catalysts were carried out via N₂ physisorption, using a Micromeritics ASAP 2020 surface area and porosity analyzer (Micromeritics Instrument Corporation, Norcross, Ga., USA) via physisorption and chemisorption analyses. N₂ physisorption was carried out to determine the specific surface areas (BET method) and pore sizes and pore volumes (BJH method) of the supports and the synthesized catalysts. The metal dispersion over the synthesized catalysts was determined via CO chemisorption. The pre-treatment for the catalyst samples was carried out in the instrument using helium gas at 110° C. for 60 min. Thereafter, the samples were reduced in-situ using a flow of H₂ gas at 350° C. for 2 h. Finally, the samples were cooled to 35° C. and CO gas was injected into the sample tube for starting the analysis. The results are provided in Table 1.

TABLE 1
Surface area, porosity and metal dispersion
analysis for synthesized catalysts.

| | | | | Molyb- | Metallic |
|---|---|---|---|---|---|
| | BET | Average | | denum | Surface |
| | Surface | Pore | Average | Disper- | Area |
| | Area | Volume | Pore Size | sion | (m²/g of |
| Sample | (m²/g) | (cm³/g) | (nm) | (%) | catalyst) |
| MWCNT | 231 ± 4 | 1.08 ± 0.04 | 16.4 ± 0.3 | — | — |
| Mo/ | 202 ± 6 | 0.93 ± 0.05 | 16.2 ± 0.2 | 0.2 | 0.11 |
| MWCNT | | | | | |
| AC | 1127 ± 5 | 0.67 ± 0.03 | 7.0 ± 0.2 | — | — |
| Mo/AC | 1253 ± 8 | 0.75 ± 0.02 | 6.8 ± 0.1 | 3.2 | 1.92 |
| BR | 249 ± 3 | 0.37 ± 0.03 | 7.0 ± 0.2 | — | — |
| Mo/BR | 118 ± 2 | 0.27 ± 0.02 | 9.7 ± 0.3 | 2.4 | 1.42 |

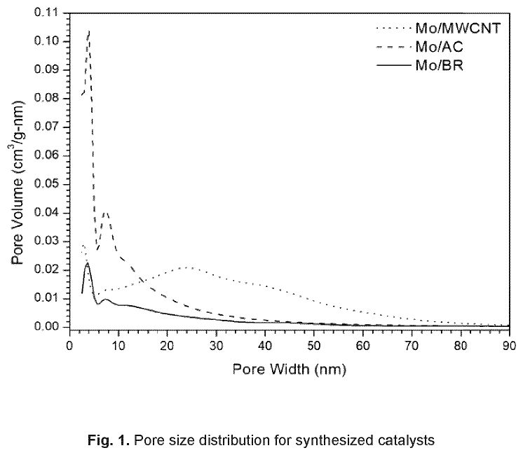

The pore size distributions for the synthesized catalysts is represented in FIG. 1, which indicates that all the carbon-supported catalyst samples had bimodal pore size distributions which is typical for porous carbonaceous materials. The bimodal shape of the curves can be attributed to the presence of micropores in the synthesized catalysts.

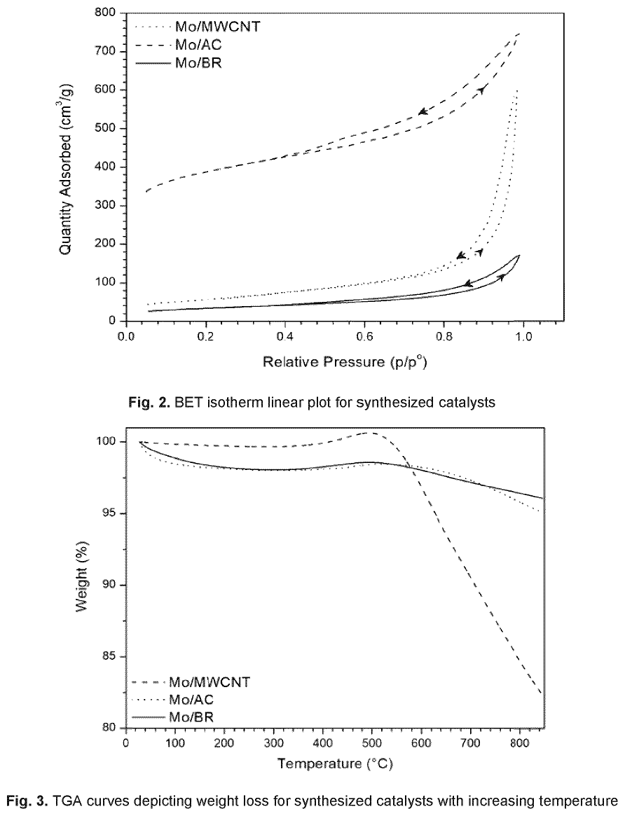

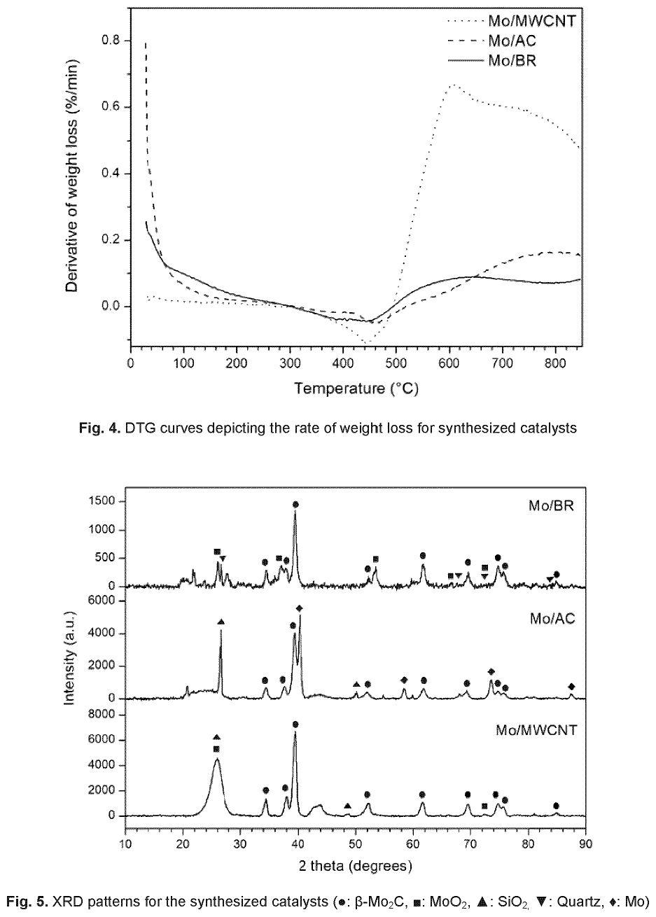

FIG. 2 shows the N₂ adsorption-desorption isotherms for the synthesized catalysts. All the samples exhibited type IV isotherms which suggest monolayer-multilayer adsorption and capillary condensation taking place in mesopores. The isotherms for Mo/AC and Mo/BR catalysts had type H4 hysteresis loops which indicate the presence of narrow slit-shaped pores. On the other hand, the isotherm for Mo/MWCNT catalyst had a type H3 hysteresis loop which suggests the presence of non-rigid aggregates of plate-like particles forming slit-shaped pores.

### a2) CO Chemisorption Analysis of the Catalyst Prepared in Examples 1b:

Chemisorption was performed on the catalyst prepared in Example 1b) to measure metal dispersion and metallic surface area according to the steps detailed in Example 3a). Metal dispersion was determined to be about 8.00% and metallic surface area was 5.50 m²/g of catalyst.

### b) Thermogravimetric Analysis (TGA) of the Catalyst Prepared in Examples 1a and 2:

A TGA Q500 instrument (TA Instruments—Waters LLC, New Castle, Del., USA) was used to evaluate the thermal stability of the synthesized catalysts via thermogravimetric analysis. The catalyst samples were heated from room temperature till 800° C. in a nitrogen (flow rate: 60 mL/min) atmosphere. Eight to ten milligrams of each catalyst were used for analysis and the temperature was increased at a ramping rate of 10° C./min. Nitrogen (flow rate: 40 mL/min) was also used as the purge gas while analysing the catalysts.

Among the three catalysts, Mo/MWCNT underwent the highest percentage of weight loss (17.7%), whereas Mo/BR exhibited the lowest percentage of weight loss (3.94%). The weight loss observed for Mo/AC was an intermediate value of 4.94%. The weight loss patterns for Mo/BR and Mo/AC were quite similar to each other (FIG. 3). Thus, Mo/BR was found to be the most stable catalyst over the temperature range studied.

### C) X-Ray Diffraction (XRD) Analysis of the Catalyst Prepared in Examples 1a and 2:

A Bruker D8 Advance Series II X-ray Powder Diffractometer (Bruker Corporation, Billerica, Mass., USA) was used to identify the structural phases in the synthesized catalysts. The diffractometer was equipped with a Cu K-α radiation source (λ=1.5406 Å) and was operated at a voltage of 40 kV with a current of 40 mA. Using a scan rate of 1.36° per minute and step size of 0.02°, the XRD data for the catalysts were collected in the two-theta range of 10-90°. Thereafter, X'Pert HighScore Plus (version 2.2.2) software was used to process the spectra and identify the peaks and corresponding phases present in the synthesized catalysts.

The desired β-Mo₂C phase was detected in the XRD spectra of all the catalyst samples (FIG. 5). The phase belonged to hexagonal lattice system and its identification validated the selection of the synthesis procedure. In Mo/MWCNT, α-Mo₂C phase was also found and ascribed to the peak at 43.52°. In addition, SiO₂ and MoO₂ phases were identified in the catalyst sample and corresponded to the peak at 26.08°. The SiO₂ and MoO₂ phases belonged to hexagonal and monoclinic lattice systems, respectively.

In Mo/AC, Mo phase (cubic lattice system) was identified instead of MoO₂ and was attributed to the peaks found at 40.38°, 58.48°, 73.48° and 87.43°. MoO₂ phase was again detected in Mo/BR catalyst and no peaks associated with Mo phase could be identified. SiO₂ was also present in Mo/AC and Mo/BR catalysts but it existed as a polymorph—quartz (hexagonal lattice system)—in the latter. In addition, calcium aluminum silicate (calcium mica) phase was identified in the Mo/BR catalyst and was ascribed to the peak at 27.71°. The calcium mica phase (monoclinic lattice system) belongs to a family of minerals known as zeolites and its presence in Mo/BR could further explain the high oxygen reduction

### d) Ammonia Temperature Programmed Desorption (NH₃-TPD) Analysis of the Catalyst Prepared in Examples 1a and 2

The strength and abundance of acidic sites on the surface of synthesized catalysts were determined via temperature programmed desorption of a gaseous base such as ammonia. The analysis was carried out using a Micromeritics AutoChem HP chemisorption analyzer (Micromeritics Instrument Corporation, Norcross, Ga., USA). The catalyst samples were purged in-situ with helium at 400° C. for 1 h to remove moisture and volatile impurities. Thereafter, the samples were cooled down and exposed to a 30 mL/min flow of 3% (v/v) NH₃/He gas mixture for 2 h. The physisorbed ammonia was removed by passing He over the samples at 100° C. for 1 h and following that, NH₃-TPD analysis was carried out by heating the catalysts from 100° C. to 800° C. at a rate of 10° C./min.

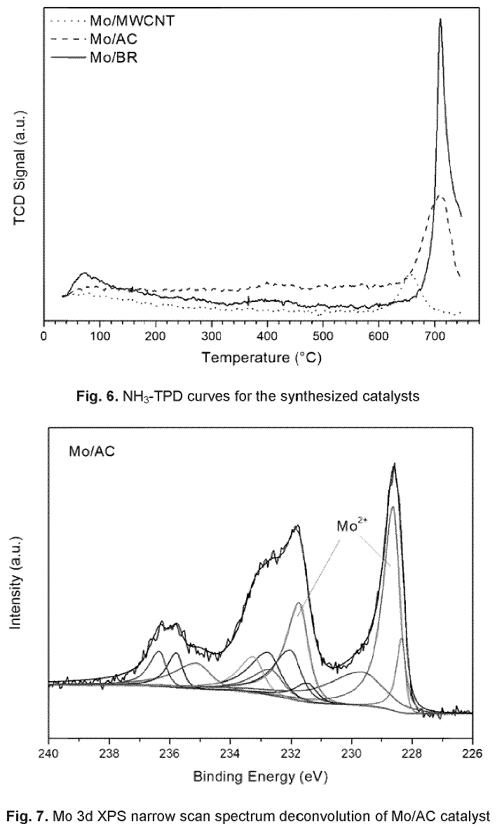

Ammonia adsorbs strongly on acidic sites and their strength depends on the desorption temperature. The acidic sites are classified as weakly acidic (<200° C.), moderately acidic (200-350° C.) and strongly acidic (>350° C.). All the catalyst samples exhibited dominant desorption peaks above 650° C. which is characteristic of very strong acid sites. Among the prepared catalysts, Mo/BR was found to have the highest number of such acid sites, while Mo/MWCNT had the lowest number of acid sites (FIG. 6). The amount of acid sites in Mo/AC was intermediate. Therefore, the superior oxygen reduction percentage observed for Mo/BR catalyst can also be attributed to the aforementioned characteristic.

### e) X-Ray Photoelectron Spectroscopic (XPS) Analysis of the Catalyst Prepared in Examples 1a and 2

The surface elemental composition and abundance of different oxidation states of the impregnated metal in the synthesized catalysts were determined via X-ray photoelectron spectroscopy. The XPS analysis was carried out using a Kratos AXIS Supra (Kratos Analytical Ltd, Manchester, UK) spectrometer at the Saskatchewan Structural Sciences Centre (SSSC). The spectrometer comes equipped with a 500 mm Rowland circle monochromated Al K-α (1486.6 eV) source and a combination of hemi-spherical analyzer (HSA) and spherical mirror analyzer (SMA). A spot size of 300×700 microns (hybrid mode) was used for the analysis. The survey scan spectra for the catalyst samples were collected in the 0-1200 eV binding energy range in steps of 1 eV using a pass energy of 160 eV. Additionally, high-resolution scans of different regions were obtained using steps of 0.05 eV with a pass energy of 20 eV. An accelerating voltage of 15 keV and an emission current of 15 mA were used for analyzing the synthesized catalysts.

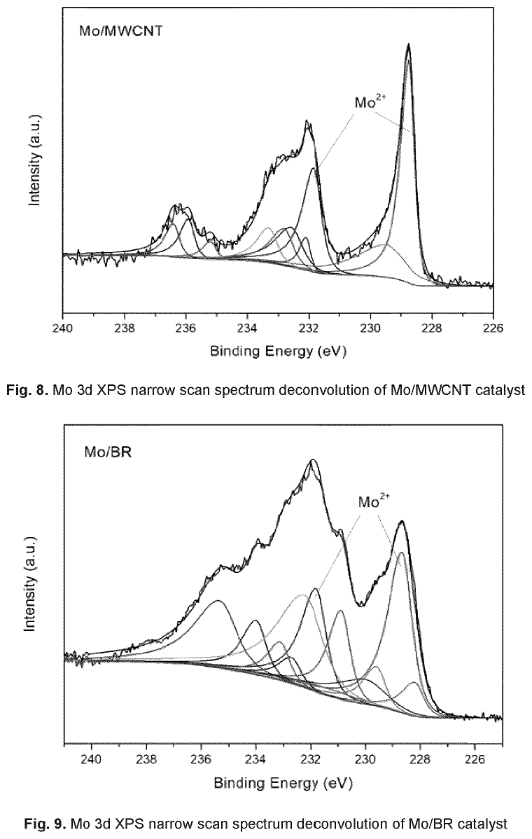

The C 1s peak at 285.0 eV was used as the reference for correcting the spectra of the catalyst samples and to account for charging effects. The XPS spectra were deconvoluted using CasaXPS (version 2.3.19PR1.0) software. Shirley background subtraction and Lorentzian Asymmetric (LA) Lineshape functions were used to deconvolute the Mo 3d peaks in the XPS spectra (FIGS. 7, 8 and 9). The Mo 3d spectrum for each catalyst was fitted by Mo⁰ at 227.8 eV, Mo²⁺ at 229.0 eV, Mo³⁺ at 229.9 eV, Mo⁴⁺ at 231.8 eV, Mo⁵⁺ at 233.1 eV and Mo⁶⁺ at 233.9 eV. Each oxidation state of molybdenum consists of two peaks resulting from spin-orbit (j-j) coupling: Mo 3d_{5/2} and Mo 3d_{3/2}. The Mo 3d_{5/2} and Mo 3d_{3/2} peaks have an area ratio of 3:2 and are separated by ˜3.1 eV. Mo/MWCNT and Mo/AC catalysts were found to have carbon, oxygen, silicon and molybdenum on their surfaces. with the amount of molybdenum being 0.15 wt. % and 0.30 wt. %, respectively (Table 2). In contrast, Mo/BR catalyst had a much higher amount of molybdenum on its surface (1.56 wt. %). Additionally, calcium and aluminium were detected on the surface of Mo/BR catalyst which corroborated the identification of calcium mica phase by XRD analysis.

TABLE 2
Surface elemental composition of the Catalysts prepared
in Examples 1a and 2 from XPS wide scan spectra.

| | Elemental Composition (wt. %) | | | | | |
|---|---|---|---|---|---|---|
| Catalyst | C | O | Si | Mo | Al | Ca |
| Mo/MWCNT | 93.00 | 6.59 | 0.26 | 0.15 | — | — |
| Mo/AC | 84.13 | 14.60 | 0.97 | 0.30 | — | — |
| Mo/BR | 21.70 | 53.11 | 20.44 | 1.56 | 3.03 | 0.17 |

Mo 3d spectrum deconvolution yields the concentration of different oxidation states of molybdenum present in the synthesized catalysts (Table 3). The β-Mo₂C phase corresponds to the Mo²⁺ oxidation state of molybdenum and it was observed that the net amount of surface Mo²⁺ species was the highest for Mo/BR catalyst. As a result, it could be inferred that Mo/BR had the highest concentration of β-Mo₂C on its surface which in turn would explain the superior oxygen reduction percentage observed for the said catalyst.

TABLE 3
Distribution of chemical states of Molybdenum from Mo 3d XPS
analysis of the Catalysts prepared in Examples 1a and 2.

| | Concentration (wt. %) | | | | | |
|---|---|---|---|---|---|---|
| Catalyst | Mo⁰ | Mo²⁺ | Mo³⁺ | Mo⁴⁺ | Mo⁵⁺ | Mo⁶⁺ |
| Mo/MWCNT | 0 | 44.35 | 23.21 | 8.36 | 12.72 | 11.36 |
| Mo/AC | 8.24 | 37.88 | 21.69 | 5.65 | 13.65 | 12.89 |
| Mo/BR | 5.21 | 32.28 | 7.19 | 9.60 | 14.97 | 30.75 |

### Example 4: Hydrodeoxygenation Reactions

### a) Preparation of Bio-Crude Blend and Hydrodeoxygenation

5 g of HTL bio-crude extracted using ethyl acetate and 45 g of ‘hydrotreated heavy gas oil’ (HHGO) were taken in a glass beaker and magnetically stirred at 120° C. for 5.5 hours to achieve a 10 wt. % blend of bio-crude in HHGO. The total weight of the feed in the reactor vessel was thus 50 g. The bio-crude blend had lower viscosity and better flowability than the pure bio-crude which facilitated handling of the feed during the upgrading process.

The 10 wt. % blend of bio-crude in hydrotreated heavy gas oil (HHGO) was hydrotreated at about 300° C. for 3 hours with a catalyst loading of 3% w/w. The temperature was increased to 290° C. at a ramping rate of 2.5° C./min. Thereafter, the temperature was slowly increased to about 300° C. in steps of 2-3° C., allowing the temperature to equilibrate before changing the set point each time. The pressure was maintained at 725 psi (5 MPa) and the stirring speed was kept at 400 RPM throughout the reaction. After completion of the reaction, the heating was switched off and the reactor vessel was allowed to cool down to room temperature. Thereafter, the product was collected in a glass bottle and N₂ was gently bubbled through the product to remove the trapped gases that were produced during the reaction.

### b) Parametric Study for Hydrodeoxygenation of Bio-Crude Blend

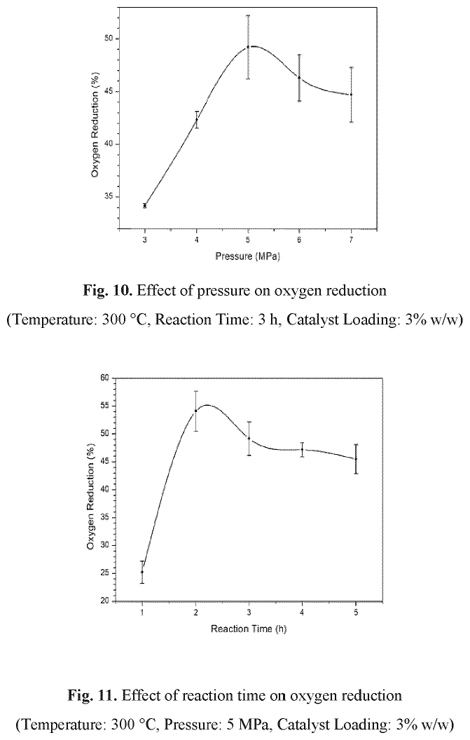

The prepared bio-crude blend was subjected to hydrodeoxygenation using the Mo/BR catalyst prepared in Example 1a), at different conditions of temperature, pressure, reaction time and catalyst loading. The reaction runs used for the parametric study and the corresponding CHNS analysis of the bio-crude blends along with the oxygen reduction percentages are shown in Tables 4, 5, 6, and 7. From the parametric study, the highest percentage of oxygen reduction (59.8±0.9%) was achieved for a reaction that was carried out at about 325° C. and 5 MPa for 2 h with a catalyst loading of 4% w/w. The effects of pressure, reaction time, temperature and catalyst loading on the oxygen reduction efficiency of prepared Mo/BR catalyst are shown graphically in FIGS. 10, 11, 12 and 13, respectively.

As shown in FIG. 10, the oxygen reduction percentage initially increases with increase in pressure and reaches its maximum value at 5 MPa. The increase in pressure leads to an increase in H₂ partial pressure within the system which facilitates enhanced mass transfer of H₂ molecules into the bulk of bio-crude blend, thus improving the percentage of oxygen reduction. However, the percentage decreases when the pressure is increased beyond 5 MPa.

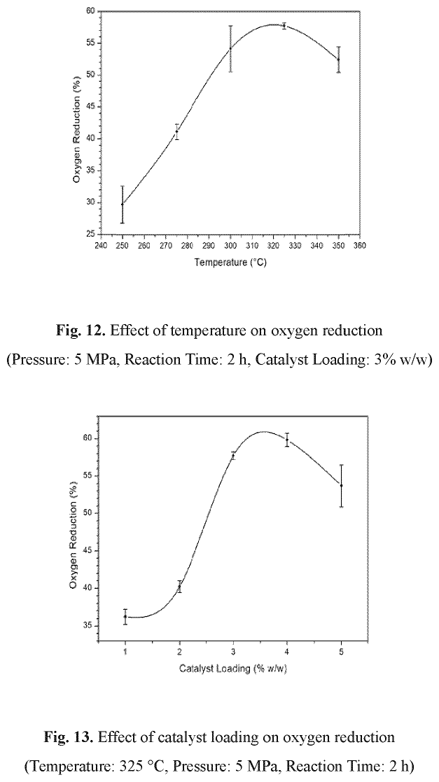

Increase in reaction time up to 2 h also promoted an increase in the oxygen reduction but for longer reaction times, a decrease in the reduction percentage was observed which can be ascribed to the occurrence of parallel secondary reactions. Similarly, the oxygen reduction improved initially with increases in temperature (up to 325° C.: FIG. 12) and catalyst loading (up to 4% w/w: FIG. 13) but tapered off due to the dominance of secondary reactions at higher values. The increase in oxygen reduction percentage observed up to 325° C. can be attributed to the increase in kinetic energy of the reactant molecules which promotes faster collisions and thereby higher rates of hydrodeoxygenation. Catalyst loading up to 4% w/w provides increasingly more active sites for HDO reaction but any further increase results in introduction of redundant active sites which favour secondary reactions and therefore, a decrease in oxygen reduction percentage is observed. Thus, the desirable values of the process parameters for carrying out hydrodeoxygenation of a bio-crude blend using Mo/BR catalyst were determined—temperature: 325° C., pressure: 5 MPa, reaction time: 2 h and catalyst loading: 4% w/w.

TABLE 4
Effect of pressure on oxygen reduction efficiency of Mo/BR catalyst of Example 1a) for
bio-crude blends (Temperature: 300° C., Catalyst Loading: 3% w/w, Reaction Time: 3 h).

| Pressure | C | H | N | S | O | Oxygen |
|---|---|---|---|---|---|---|
| (MPa) | (wt. %) | (wt. %) | (wt. %) | (wt. %) | (wt. %) * | Reduction (%) |
| Blend | 86.33 ± 0.05 | 10.54 ± 0.02 | 0.44 ± 0.02 | 0.23 ± 0.02 | 2.46 ± 0.07 | |
| 3 | 86.24 ± 0.02 | 11.70 ± 0.03 | 0.34 ± 0.01 | 0.10 ± 0.003 | 1.62 ± 0.05 | 34.2 ± 0.2 |
| 4 | 86.44 ± 0.05 | 11.58 ± 0.01 | 0.43 ± 0.003 | 0.13 ± 0.02 | 1.42 ± 0.06 | 42.3 ± 0.8 |
| 5 | 86.47 ± 0.04 | 11.76 ± 0.07 | 0.42 ± 0.01 | 0.10 ± 0.01 | 1.25 ± 0.11 | 49.2 ± 3.0 |
| 6 | 86.43 ± 0.05 | 11.74 ± 0.04 | 0.39 ± 0.02 | 0.12 ± 0.001 | 1.32 ± 0.09 | 46.3 ± 2.2 |
| 7 | 86.52 ± 0.06 | 11.57 ± 0.05 | 0.43 ± 0.06 | 0.12 ± 0.01 | 1.36 ± 0.10 | 44.7 ± 2.6 |

* Calculated by difference

TABLE 5
Effect of reaction time on oxygen reduction efficiency of prepared Mo/BR catalyst for
bio-crude blends (Temperature: 300° C., Pressure: 5 MPa, Catalyst Loading: 3% w/w).

| Reaction | C | H | N | S | O | Oxygen |
|---|---|---|---|---|---|---|
| Time (h) | (wt. %) | (wt. %) | (wt. %) | (wt. %) | (wt. %) * | Reduction (%) |
| Blend | 86.33 ± 0.05 | 10.54 ± 0.02 | 0.44 ± 0.02 | 0.23 ± 0.02 | 2.46 ± 0.07 | |
| 1 | 85.92 ± 0.08 | 11.64 ± 0.03 | 0.41 ± 0.01 | 0.19 ± 0.02 | 1.84 ± 0.10 | 25.2 ± 2.0 |
| 2 | 86.69 ± 0.07 | 11.71 ± 0.05 | 0.36 ± 0.01 | 0.11 ± 0.001 | 1.13 ± 0.12 | 54.1 ± 3.6 |
| 3 | 86.47 ± 0.04 | 11.76 ± 0.07 | 0.42 ± 0.01 | 0.10 ± 0.01 | 1.25 ± 0.11 | 49.2 ± 3.0 |
| 4 | 86.41 ± 0.01 | 11.77 ± 0.06 | 0.42 ± 0.02 | 0.10 ± 0.001 | 1.30 ± 0.07 | 47.2 ± 1.3 |
| 5 | 86.48 ± 0.03 | 11.62 ± 0.07 | 0.44 ± 0.06 | 0.12 ± 0.01 | 1.34 ± 0.10 | 45.5 ± 2.6 |

* Calculated by difference

TABLE 6
Effect of temperature on oxygen reduction efficiency of prepared Mo/BR catalyst for
bio-crude blends (Pressure: 5 MPa, Reaction Time: 2 h, Catalyst Loading: 3% w/w).

| Temperature | C | H | N | S | O | Oxygen |
|---|---|---|---|---|---|---|
| (° C.) | (wt. %) | (wt. %) | (wt. %) | (wt. %) | (wt. %) * | Reduction (%) |
| Blend | 86.33 ± 0.05 | 10.54 ± 0.02 | 0.44 ± 0.02 | 0.23 ± 0.02 | 2.46 ± 0.07 | |
| 250 | 85.91 ± 0.09 | 11.88 ± 0.03 | 0.39 ± 0.002 | 0.09 ± 0.001 | 1.73 ± 0.12 | 29.7 ± 2.9 |
| 275 | 86.25 ± 0.05 | 11.74 ± 0.02 | 0.44 ± 0.04 | 0.12 ± 0.01 | 1.45 ± 0.07 | 41.1 ± 1.2 |
| 300 | 86.69 ± 0.07 | 11.71 ± 0.05 | 0.36 ± 0.01 | 0.11 ± 0.001 | 1.13 ± 0.12 | 54.1 ± 3.6 |
| 325 | 86.63 ± 0.02 | 11.80 ± 0.02 | 0.42 ± 0.04 | 0.11 ± 0.005 | 1.04 ± 0.04 | 57.7 ± 0.5 |
| 350 | 86.57 ± 0.06 | 11.75 ± 0.02 | 0.38 ± 0.002 | 0.13 ± 0.003 | 1.17 ± 0.08 | 52.4 ± 2.0 |

* Calculated by difference

TABLE 7
Effect of catalyst loading on oxygen reduction efficiency of prepared Mo/BR catalyst
for bio-crude blends (Temperature: 325° C., Pressure: 5 MPa, Reaction Time: 2 h).

| Catalyst | | | | | | |
|---|---|---|---|---|---|---|
| Loading | C | H | N | S | O | Oxygen |
| (% w/w) | (wt. %) | (wt. %) | (wt. %) | (wt. %) | (wt. %) * | Reduction (%) |
| Blend | 86.33 ± 0.05 | 10.54 ± 0.02 | 0.44 ± 0.02 | 0.23 ± 0.02 | 2.46 ± 0.07 | |
| 1 | 86.06 ± 0.03 | 11.71 ± 0.04 | 0.44 ± 0.003 | 0.22 ± 0.05 | 1.57 ± 0.07 | 36.2 ± 1.0 |
| 2 | 86.38 ± 0.05 | 11.66 ± 0.01 | 0.40 ± 0.01 | 0.09 ± 0.004 | 1.47 ± 0.06 | 40.2 ± 0.8 |
| 3 | 86.63 ± 0.02 | 11.80 ± 0.02 | 0.42 ± 0.04 | 0.11 ± 0.005 | 1.04 ± 0.04 | 57.7 ± 0.5 |
| 4 | 86.68 ± 0.04 | 11.78 ± 0.01 | 0.38 ± 0.004 | 0.17 ± 0.01 | 0.99 ± 0.05 | 59.8 ± 0.9 |
| 5 | 86.58 ± 0.06 | 11.74 ± 0.04 | 0.42 ± 0.01 | 0.12 ± 0.01 | 1.14 ± 0.10 | 53.7 ± 2.8 |

* Calculated by difference

### Example 4: Characterization of Bio-Crude Blends

### a) Moisture Content Analysis

The moisture content in the bio-crude blends was determined by Karl-Fischer coulometric titration and the results were reported as weight percentages of moisture. Prior to hydrodeoxygenation, the bio-crude blend contained 0.021±0.002 wt. % of moisture, whereas the hydrodeoxygenated bio-crude blend contained 0.025±0.001 wt. % of moisture. The increase in moisture content can be attributed to the formation of H₂O molecules during the hydrodeoxygenation reaction. In spite of the slight increase, the moisture content in the hydrodeoxygenated bio-crude blend was well within the permissible limit of 0.05 wt. %.

### b) Boiling Point Distribution Analysis

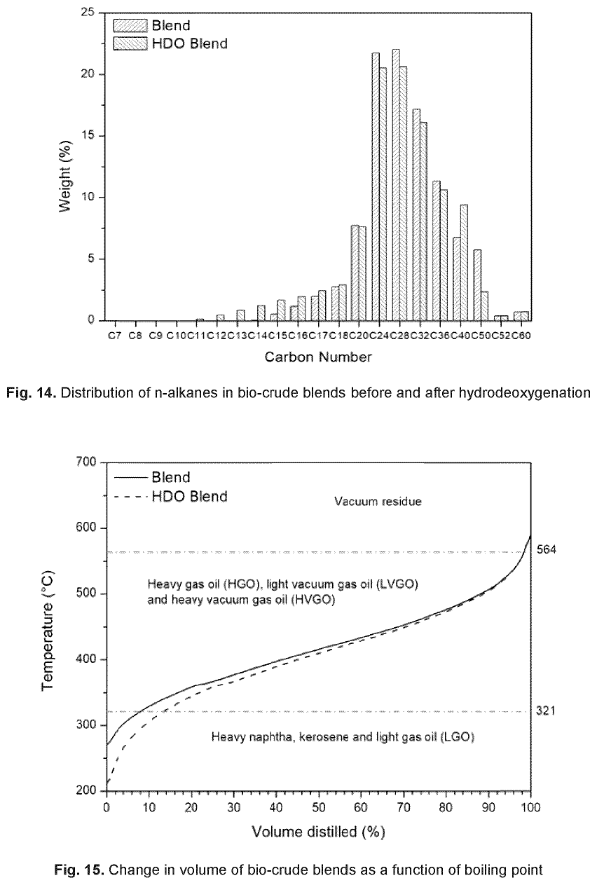

The boiling point distributions of the bio-crude blends (Blend and HDO Blend) have been shown in FIG. 14. The Sim-Dist data was calibrated using n-alkane standards and it was observed that before hydrodeoxygenation, the bio-crude blend contained no n-alkanes in the C₇-C₁₃ carbon range. The majority (72.3 wt. %) of n-alkanes were found in the C₂₄-C₃₆ range.

However, the hydrodeoxygenated blend contained a small fraction (1.45 wt. %) of n-alkanes in the C₁₁-C₁₃ range while none could be found in the C₇-C₁₀ range. It was also observed that the percentage of n-alkanes (67.86 wt. %) in the C₂₄-C₃₆ range decreased after hydrodeoxygenation. On the other hand, the fraction of n-alkanes in the C₁₃-C₂₄ range (Blend: 35.9 wt. %, HDO Blend: 39.2 wt. %) and C₁₅-C₂₀ range (Blend: 14.1 wt. %, HDO Blend: 16.6 wt. 30%) increased in the bio-crude blend after undergoing hydrodeoxygenation which suggests that hydrocracking also took place during the HDO reaction (FIGS. 14 and 15).

### c) ¹H NMR Spectroscopic Analysis

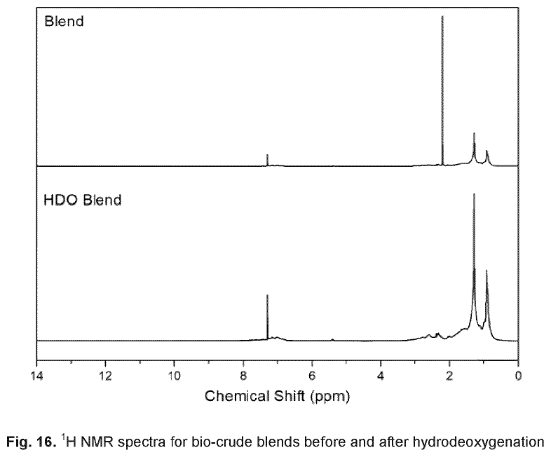

The ¹H NMR spectra of the bio-crude blends before and after hydrodeoxygenation are shown in FIG. 16 and the quantitative percentages of different types of hydrogen present in the samples are reported in Table 8. It was observed that the concentration of aliphatic protons increased from 63.8% to 71.6%, whereas the quantity of aliphatic hydroxyl protons decreased slightly after the reaction. The hydrodeoxygenated blend also contained lower concentrations of aromatics and ethers than the untreated blend. Phenolic hydroxyl groups and non-conjugated alkenes were not detected in both the bio-crude blends. The chemical shift range of 2.2-3.0 ppm was assigned to protons located alpha to ketones, aldehydes and carboxylic groups and benzylic protons. The intensity in this range is related to the intensity observed in the chemical shift range of 8.0-13.0 ppm which was assigned to protons located on aldehydes, carboxylic acids and downfield aromatics. The hydrogen concentrations in both these ranges reduced after hydrodeoxygenation which indicates effective removal of the aforementioned bio-crude oxygenates and aromatics.

TABLE 8
Quantitative percentages of different types of hydrogen
present in bio-crude blends based on ¹H NMR spectra.

| Chemical | | Hydrogen Content | |
|---|---|---|---|
| Shifts | | (% of all hydrogen) | |
| (ppm) | Assignment of Protons | Blend | HDO Blend |
| 0-1.6 | Aliphatic (—CH₃, —CH₂—) | 63.8 | 71.6 |
| 1.6-2.2 | Aliphatic Hydroxyls (—OH) | 12.5 | 11.5 |
| 2.2-3.0 | CH₃C═O, CH₃Ar, —CH₂Ar | 16.0 | 10.2 |
| 3.0-4.2 | CH₃O—, —CH₂O—, ═CHO— | 0.9 | 0.8 |
| 4.2-6.5 | ArOH, non-conjugated | BD | BD |
| | alkenes (HC═C) | | |
| 6.5-8.0 | ArH, conjugated alkenes (HC═C) | 6.6 | 5.9 |
| 8.0-13.0 | —COOH, —CHO, downfield ArH | 0.1 | BD |

*BD: Below Detection

### d) CHNS Analysis of Bio-Crude Blends Before and After Hydrodeoxygenation

The CHNS analysis of bio-crude blends before and after hydrodeoxygenation using each of the three synthesized catalysts (i.e. Mo/MWCNT, Mo/AC and Mo/BR) is provided in Table 9. The (H/C) ratios for all the hydrodeoxygenated blends were greater than that of the untreated blend. All the post-HDO blends exhibited significant decreases in the amounts of sulphur and oxygen.

TABLE 9
CHNS analysis for bio-crude blends hydrotreated with prepared Mo/MWCNT, Mo/AC catalysts of Example 2 and
Mo/BR catalyst of Example 1a) (Temp: 300° C., Pressure: 5 MPa, Catalyst Loading: 3% w/w, Time: 3 h).

| | C | H | N | S | O | (H/C) | Oxygen |
|---|---|---|---|---|---|---|---|
| Sample | (wt. %) | (wt. %) | (wt. %) | (wt. %) | (wt. %) * | ratio | Reduction (%) |
| Blend | 86.33 ± 0.05 | 10.54 ± 0.02 | 0.44 ± 0.02 | 0.23 ± 0.02 | 2.46 ± 0.07 | 1.45 | |
| Blend_Mo/MWCNT | 85.98 ± 0.03 | 11.54 ± 0.05 | 0.43 ± 0.06 | 0.12 ± 0.013 | 1.93 ± 0.08 | 1.60 | 21.5 ± 1.0 |
| Blend_Mo/AC | 85.89 ± 0.05 | 11.65 ± 0.05 | 0.44 ± 0.04 | 0.11 ± 0.002 | 1.91 ± 0.10 | 1.62 | 22.4 ± 1.8 |
| Blend_Mo/BR | 86.47 ± 0.04 | 11.76 ± 0.07 | 0.42 ± 0.01 | 0.10 ± 0.01 | 1.25 ± 0.11 | 1.62 | 49.2 ± 3.0 |

* Calculated by difference

The molybdenum catalyst synthesized using bio-residue as the support exhibited a higher oxygen reduction percentage for the prepared bio-crude blend than the catalysts synthesized using commercial multi-walled carbon nanotubes and commercial activated carbon.

The hydrodeoxygenation performance of the bio-residue-based catalyst of the present invention was also compared with commercial CoMo/γ-Al₂O₃ and NiMo/γ-Al₂O₃ catalysts. The bio-residue-based catalyst performed much better than commercial CoMo/γ-Al₂O₃ and NiMo/γ-Al₂O₃ catalysts in terms of oxygen reduction efficiency.

The bio-residue-based molybdenum catalyst had a high percentage of molybdenum dispersion, the highest number of strongly acidic sites, highest concentration of β-Mo₂C on its surface and an optimum average pore size. The aforementioned characteristics might explain the superior oxygen reduction efficiency of the bio-residue-based catalyst.

The highest oxygen reduction percentage using the bio-residue-based catalyst was achieved for a given set of reaction conditions. The bio-crude blend also underwent hydrocracking during the hydrodeoxygenation process and as a result, the fraction of n-alkanes in the C₁₃-C₂₄ and C₁₅-C₂₀ ranges increased after hydrodeoxygenation. Furthermore, the concentration of aliphatic compounds increased and that of carbonyl-group containing oxygenates and aromatics decreased in the bio-crude blend after hydrodeoxygenation.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A hydrodeoxygenation catalyst comprising molybdenum carbide (Mo₂C) supported on a bio-residue support, wherein the catalyst has a concentration of strong acidic sites of more than 0.25 mmol/g of the catalyst, as measured by ammonia temperature programmed desorption (NH₃-TPD) analysis.

2. The catalyst of claim 1, further having a BET surface area of 100 m²/g to 200 m²/g.

3. The catalyst of claim 1, further having an average pore size of about 7.5 nm to about 12 nm and/or a pore volume of about 0.2 cm³/g to about 0.3 cm³/g.

4. The catalyst of claim 1, further having surface concentration of β-MO₂C more than 0.3%.

5. The catalyst of claim 1, further having molybdenum dispersion of about 2% to about 15%.

6. Use of the catalyst as defined in claim 1 to catalyze a hydrodeoxygenation reaction.

7. A process for preparing a bio-residue supported molybdenum carbide (Mo₂C) catalyst, the method comprising:
a) treating the bio-residue with an acid at a temperature of about 50° C. to about 150° C. to introduce oxygen functional groups on the surface to provide an oxygenated bio-residue;
b) impregnating the oxygenated bio-residue with a molybdenum precursor to achieve Mo loading of about 10%-20% by weight of the catalyst to provide a precursor-impregnated bio-residue;
c) drying and calcining the precursor-impregnated bio-residue under an inert atmosphere, at a temperature of about 450° C. to about 600° C. to provide a calcined precursor-impregnated-bio-residue; and
d) reducing the calcined precursor-impregnated-bio-residue in hydrogen atmosphere at a H₂ flow rate of about 75-125 mL/min at a temperature of about 600° C. to about 800° C. to obtain the bio-residue supported molybdenum carbide catalyst.

8. The process of claim 7, wherein the oxygenated bio-residue is impregnated via an incipient wetness impregnation method, a dip method impregnation and/or a spray impregnation method.

9. The process of claim 7, further comprising passivating the catalyst obtained in step d) by flowing about 1-2% O₂ in N₂ at a flow rate of about 50 mL/min to about 250 mL/min over the surface of the catalyst.

10. The process of claim 7, wherein the drying step comprises drying the precursor-impregnated bio-residue under vacuum at about 80° C. to about 120° C. prior to the calcining step.

11. The process of claim 7, further comprising preheating the bio-residue at a temperature about 300° C. to about 350° C.

12. The process of claim 7, wherein the molybdenum precursor is ammonium heptamolybdate.

13. The process of claim 7, wherein the acid is HNO₃.

14. The process of claim 7, wherein the acid has a molar concentration of 0.1 M to 7 M.

15. The process of claim 7, further comprising adding a binder to the calcined precursor-impregnated-bio-residue to form pellets and/or tablets.

16. The process of claim 15, wherein the binder is bentonite clay.

17. The process of claim 15, wherein the binder is added in an amount about 10% to 20% by weight of the calcined precursor-impregnated-bio-residue.

18. The process of claim 15, wherein the pellets have a shape selected from cylindrical, bilobed, trilobed, and/or quadrilobed.

19. The process of claim 15, wherein the process is carried out as a batch process.

20. The process of claim 15, wherein the process is carried out as a continuous flow process.

21. A process for hydrodeoxygenation of an oxygen rich feedstock, the process comprising:
hydrotreating the feedstock at a temperature of about 250° C. to about 350° C., and a pressure of about 3 MPa to about 7 MPa, for about 1 h-5 h in the presence of the bio-residue supported molybdenum carbide (Mo₂C) catalyst as defined in claim 1, with catalyst loading of about 1-5% w/w of the amount of bio-crude in the feedstock.

22. The process of claim 16, wherein the oxygen rich feedstock is a biomass derived feedstock comprising bio-crude, pyrolysis oil, vegetable oil, waste cooking oils, bio-lipids, renewable fuel, or a combination thereof.

23. The process of claim 22, wherein the oxygen rich feedstock further comprises a refinery distillate.

24. The process of claim 23, wherein the feedstock comprises about 5-15% by weight of the bio crude in the refinery distillate.
